(19) United States
(12) Patent Application Publication
(10) Pub. No.: US 2007/0241516 A1
(43) Pub. Date: Oct. 18, 2007

(54) Negative creep gasket with core of shape memory alloy

(76) Inventor: Anatoly Efremov, Albuquerque, NM (US)

Correspondence Address: ANATOLY EFREMOV, 9923 Osuna Rd., NE, Albuquerque, NM, 87111, US

(21) Appl. No.: 11/405,722

(22) Filed: Apr. 18, 2006

(51) Int. Cl. F16L 17/00

(52) U.S. Cl. 277/626

(57) ABSTRACT

A negative creep gasket with core of shape memory alloy to ensure a leak-tight, automatic and continuous multiple seal of critical plat/piping systems comprises a corrugated core manufactured from shape memory alloy and shape-memorized in advance to the “swelling” under conditions of rigidly fixed corrugation followed by aging under temperature significantly greater than temperature of austenite state of the shape memory alloy. Temperature interval of reverse martensitic phase transformation of the shape memory alloy is close to process temperatures of the assembly. Negative creep effect of the gasket results from shape-recovering stresses that appear between rigid flange surfaces and deformed by bolt preload corrugation during constrained shape recovery of the gasket core under conditions of a variety of operating temperatures and internal pressures.

### CROSS-REFERENCE TO RELATED APPLICATION

This Patent Application claims an earlier filed Provisional Patent Application No. 60/671,419, filed Apr. 15, 2005, the disclosure of which is hereby incorporated herein by references; and this Patent Application is a continuation-in-part of the U.S. Patent Application No. 2005244245-A1, filed on Apr. 30, 2004.

### FEDERALLY SPONSORED RESEARCH

Not Applicable

### SEQUENCE LISTING OR PROGRAM

Not Applicable

### BACKGROUND OF THE INVENTION—FIELD OF THE INVENTION

This invention relates to novel type of gaskets displaying “negative creep effect” and providing tight, automatic and continuous multiple seal to ensure leak-tight joint between adjacent members of pressure vessels, piping systems and the like under conditions of extended action of a variety of operating temperatures, high internal pressures, and other critical factors.

### BACKGROUND OF THE INVENTION—PRIOR ART

Bolted flanged connections with gaskets as sealing elements used in plant/piping systems of petroleum refining, petrochemicals, fossil fuel and nuclear power generation, aerospace, automobile, submarine shipbuilding, and other industries experience operating leakages due to the loss of leak tightness of gasketed joints. The operating leakage consequences are difficult to estimate, but the fires, explosions, environmental pollutions, accompanied by huge material and financial losses due to plant shutdowns, production penalties, maintenance rework activities, equipment replacement or repair, and so on are direct relatives of operating leakages.

One of the main reasons of the leakages is a creep relaxation of the gaskets that operate under critical conditions including a variety of operating temperatures, high internal pressures, flow-induced vibrations, integral flow of neutrons, and others. Many thousands of patent documents concerning to gasket materials and gasket styles underline the importance of operating leakage problem, and simultaneously they testify that previous approaches proposing regular “excellent” gasket materials or sophisticated gasket styles cannot guarantee the safe and extended service life of critical engineering structures containing bolted flanged connections with gasketed joints.

One of the popular ways to limit plant/piping leakages consists in the use of special techniques to create a multiple seal between adjacent members of the bolted flanged connections. Doty, who proposed a metallic gasket having a corrugated shape to provide a multiple contact between corrugation and flange surfaces, disclosed the principal idea of this approach in one of the oldest U.S. Pat. No. 222,388. This idea was developed in next U.S. Pat. No. 854,135 by Whittemore and U.S. Pat. No. 922,130 by Goetze. First of them discloses a fabric gasket with a corrugated transversally-stiff metallic core, and second describes a gasket comprising two-layers metallic disk that is formed of a series of annular concentric corrugations with asbestos corrugated packing between metallic layers of the disk. In last case the metallic corrugations are intended to form solid supports for asbestos packing that can provide a fluid-tight seal because the packing material is held firmly and effectively against the lateral movement upon the metallic retaining disk of the packing.

The idea of gasket corrugation continues to be used for more than one century but new modern approaches consist in application of corrugated metallic gasket cores that, being deformed by gasket compression due to bolt preload, can provide spring forces between corrugation and flange surfaces. These spring forces create a multiple fluid-locked barriers to ensure a necessary leak-tight joint. The multiple annular seal may be obtained with gasket comprising some concentric, separate, radially spaced metallic corrugations with protective envelope manufactured from materials convenient for critical process conditions such as high temperatures and internal pressures, oxidation, fire events, chemical influences, and the like. The expanded layers of protective materials maintain the contour of the functional corrugations.

The U.S. Pat. No. 1,030,055 to Darlington, U.S. Pat. No. 2,006,381 to Bailey, U.S. Pat. No. 3,595,589 to Henderson, U.S. Pat. No. 4,026,565 to Jelinek, U.S. Pat. No. 4,234,638 to Yamazoe et al., U.S. Pat. No. 4,485,138 to Yamamoto et al., U.S. Pat. No. 4,676,515 to Cobb, U.S. Pat. No. 4,705,278 to Locasius et al., U.S. Pat. No. 4,795,174 to Whitlow, U.S. Pat. No. 5,421,594 to Becerra, U.S. Pat. No. 5,556,113 to Amorese et al., U.S. Pat. No. 5,558,347 to Nicholson, U.S. Pat. No. 6,092,811 to Bojarczuk et al., and Foreign Patent Documents Nos. FR1118630, EP268134, GB2229047, RU2016305 describe the practical approaches to create gasket materials and gaskets providing multiple seal by utilizing the gasket cores of functionally corrugated metals encapsulated by protective envelopes.

All these inventions disclose approaches to form corrugated gasket cores that are preferably constructed of similar metals such as aluminum, brass, copper or stainless steel (e.g. 304, 309, 310, 316, 321, 347, 410, 430, 501). The further selection of metal depends upon the metallurgy of the flanges to be sealed, and on the degree of chemical resistance desired from the metal gasket core. This range includes Alloy 20, Hasalloy B and C, Inconel 600, Incolloy 825, Monel, and others.

It is well known that all these metals used in core fabrication experience, one way or another, the creep relaxation under conditions of a variety of process temperatures and load-induced stresses, so that the spring feature and trapping action of corrugated compressed core will be inevitably decreased during long exposure to the load and thermal influences. The creep relaxation of gasket materials and gaskets is common characteristics of all existing approaches to improve leak tightness of gasketed joints. This feature defines “passive” behavior of gasket materials and gasket styles under critical operating conditions that inevitably leads to routine leakages.

The present invention discloses a novel type of the gaskets based on new sealing technology described by my own US Patent Application No. 20050244245-A1 as “negative creep” effect that provides an “active” resistance of the gaskets to the creep relaxation. This approach uses the feature of gaskets with corrugated cores manufactured on a basis of advanced shape memory materials to ensure a tight, automatic, reliable and continuous seal of the gasketed joints under critical operating conditions.

### BACKGROUND OF THE INVENTION—OBJECTS AND ADVANTAGES

It is, therefore, a primary object of the present invention to provide a practical and efficient development of new sealing technology based on negative creep effect of the gaskets with corrugated cores manufactured from shape memory alloys having temperature interval of reverse martensitic phase transformation close to operating temperature of the assembly.

The next object of the present invention is to form novel type of the gaskets that limits or inhibits operating creep relaxation while subjecting the bolted flanged connections to high internal pressures with a variety of operating temperatures and ensuring a reliable gasketed joint of critical engineering structures used in petroleum refining, petrochemicals, fossil fuel and nuclear power generation, and other process industries.

The negative creep effect of the gasket results from reactive shape-recovering stresses that appear during constrained recovery of shape-memorized deformation that is a gasket core corrugation obtained in advance under condition of formation of stress-induced martensite. Due to constrained shape recovery of deformed by bolt preload corrugated gasket core, the reactive shape-recovering stresses having direction inverse to the direction of operating creep of the gasket core cause the “swelling” of the gasket that excludes the contraction of the gasket due to operating creep.

It is another object of the invention to provide the method to fabricate the gasket cores of shape memory alloys that display the negative creep effect under operating conditions.

The method consists in fabrication of corrugated gasket core of suitable shape memory alloys under conditions of formation of stress-induced martensite and temperature of martensite state followed by aging of obtained and rigidly fixed corrugation under temperature significantly greater than temperature of austenite state of the shape memory alloy. After convenient aging, the rigidly fixed corrugation is then released from fixation under temperature of martensite state of the shape memory alloy. This method may be called a “forced fixation technique”, and it can find a widespread application in negative creep gasket manufacturing.

The corrugated gasket core, being deformed by clamping force due to bolt preload, will attempt to recover its initial shape if temperature of reverse martensitic phase transformation of the shape memory alloy will be close to process temperature of the assembly. This effect corresponds to the “swelling” of the gasket, and rigid flanges will block this swelling providing the constrained shape recovery accompanied by reactive shape-recovering stresses that appear between rigid flange surfaces and deformed corrugation. The negative creep effect of the gasket core is the consequence of reactive shape-recovering stresses having direction inverse to the direction of operating creep.

It is final object of the present invention to provide the gaskets with cores manufactured from shape memory alloys intended for specific process conditions including operating temperatures that are close to temperatures of reverse martensitic phase transformation of the shape memory alloys.

A most important advantage of the present invention is a novel type of the gaskets that is quite different from any conventional ones because the novel gaskets display negative creep effect that defines their active resistance to operating creep relaxation.

Another advantage of the present invention consists in use of reactive shape-recovering stresses generated by deformed gasket corrugation while recovery of its initial shape. The reactive shape-recovering stresses provide leak-tight, automatic and continuous contact between flange surfaces and corrugated gasket that creates multiple strong barriers against operating leakages ensuring safe and extended service life of bolted flanged connections used in critical engineering applications.

Further brief description of applied drawings followed by detailed description of the invention is intended to provide a basis for understanding the nature and character of the present invention, and to explain the main principles and operation of presented negative creep gasket.

### SUMMARY

In accordance with the present invention, a gasket comprises a corrugated core manufactured from shape memory alloys having feature of negative creep effect resulting from reactive shape-recovering stresses that appear during the constrained shape recovery of deformed by bolt preload corrugation under critical operating conditions including a variety of operating temperatures that are close to temperatures of reverse martensitic phase transformation of used shape memory alloy.

### DRAWINGS—FIGURES

FIG. 1a is a cross-sectional view of a part of the negative creep gasket after formation of corrugated core manufactured from shape memory alloy and encapsulated by convenient protective envelope.

FIG. 1b is a cross-sectional view of the same part of the negative creep gasket shown in FIG. 1a except that the corrugation is compressed by bolt preload forces (not shown) and subjected to operating temperature “T” and then to internal pressure “p”.

FIG. 2a is a cross-sectional view of a part of negative creep gasket with corrugated core that is similar to that shown in FIG. 1a, but corrugated part of the gasket is combined with additional non-corrugated portion of the gasket having the same encapsulation and located on inner edge of the gasket.

FIG. 2b is a cross-sectional view of the same part of negative creep gasket shown in FIG. 2a except that the corrugation and additional non-corrugated portion of the gasket are compressed by bolt preload forces (not shown) and subjected to operating internal pressure “p” and then to temperature “T”.

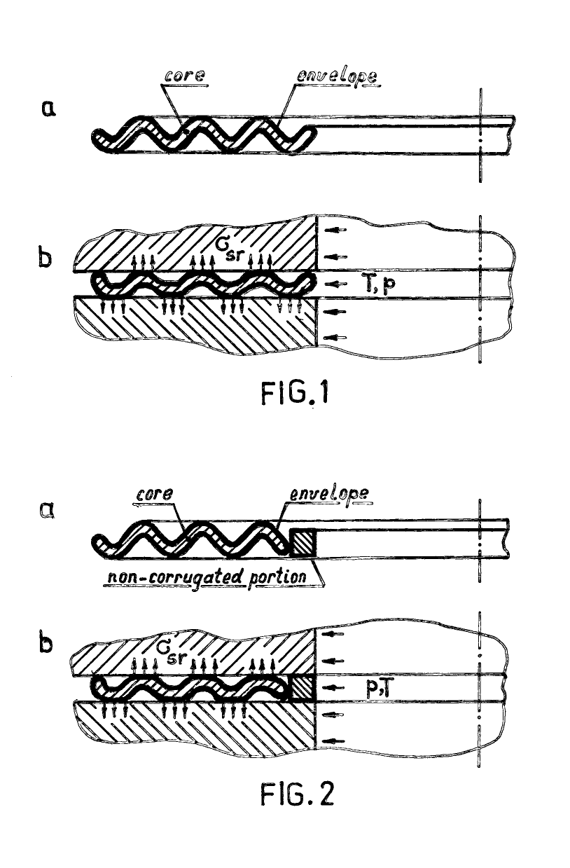

### DETAILED DESCRIPTION: FIG. 1—PREFERRED AMBODIMENT

Creep relaxation of any conventionally used corrugated gasket cores relates to “passive” behavior of the gaskets under critical operating conditions that leads to the leakages because of gasket thickness loss due to time-temperature aging effect of the core metals.

The present invention is a further development of negative creep effect displayed by corrugated gasket core under operating conditions including extended temperature influence and high internal pressure. The disclosed novel type of the gaskets is practical application of new sealing philosophy based on “active” resistance of the gaskets to operating creep relaxation. These gaskets include corrugated cores manufactured from convenient shape memory alloys having temperature intervals of reverse martensitic phase transformations close to operating temperatures of the assemblies.

The corrugated shape of the gasket cores shown in FIGS. 1a and 2a are obtained from a flat sheet or strip of convenient shape memory alloy. First step includes a fabrication of a flat gasket ring from the sheet or strip. For example, the flat strip is initially wound into flat coil under temperature of martensite state. The free ends of the coil are then welded to form a closed flat ring. This ring is further placed under press having specific profile convenient to form a necessary gasket corrugation under temperature of martensite state of the shape memory alloy that corresponds to formation of stress induced martensite. The corrugation is then rigidly fixed and subjected to the aging under temperature significantly greater than temperature of austenite state of shape memory alloy. This procedure corresponds to “forced fixation technique”, and after convenient time of aging the corrugation is released from fixation under temperature of martensite state of shape memory alloy obtaining necessary initial shape of the gasket core. Obtained corrugated gasket core is then encapsulated by protective envelope manufactured from materials convenient for specific process conditions including fires, oxidation, chemical influences, and others.

The clamping forces due to bolt preload compress initial corrugation of the gasket core (FIG. 1b), and when operating temperature “T” becomes close to the temperature of reverse martensitic phase transformation of shape memory alloy, the deformed core will attempt to recover its initial undeformed shape shown in FIG. 1a. This process corresponds to gasket “swelling”, but this shape recovery will be blocked by rigid flanges providing constrained shape recovery with appearance of reactive shape-recovering stresses “σₛᵣ” having direction inverse to the direction of operating creep of the gasket. Described mechanism corresponds to negative creep effect of the gasket, and described type of the negative creep gasket relates to typical process conditions when the gasket and flanges are heated or cooled with operating temperature “T”, and the contained pressure “p” is then raised.

The corrugation may have a plurality shapes from sinusoidal, U—inverted U, V—inverted V, or other similar shapes, or combinations thereof. Materials convenient for specific operating conditions encapsulate the corrugated core forming negative creep gasket. As an example, triangular shape of the corrugated gasket core is shown in FIG. 1, which is schematic representations of the gasket before installation (FIG. 1a) and after installation, i.e. in service under conditions of operating temperature “T” followed by internal pressure “p” (FIG. 1b).

The constrained shape recovery of the corrugated gasket core generates reactive shape-recovering stresses “σₛᵣ” having direction inverse to the direction of operating creep of the gasket that defines the negative creep effect of the gasket.

FIG. 2a represents the gasket that is similar to that shown in FIG. 1a except that the corrugated core is combined with additional flat non-corrugated portion of the gasket manufactured from the same shape memory alloy with the same protective envelope or from conventional gasket materials. The non-corrugated portion is located on inner edge of the gasket. This type of the negative creep gasket relates to operating conditions when flanged connection with gasketed joint is subjected to internal pressure “p”, and operating temperature “T” is then applied.

The clamping forces due to bolt preload compress the corrugation and additional non-corrugated portion of the gasket (FIG. 2b) to maintain an increase of internal pressure “p”, and when operating temperature “T” will be close to the temperature of reverse martensitic phase transformation of the shape memory alloy the deformed corrugation will attempt to recover its initial non-deformed shape shown in FIG. 2a. This process corresponds to gasket “swelling”, but rigid flanges providing constrained shape recovery will block this gasket “swelling” with appearance of reactive shape-recovering stresses “σₛᵣ” between deformed corrugation and flange surfaces.

Additional non-corrugated portion of the gasket may be manufactured from the same shape memory alloy or from conventional gasket materials. In the first case, the non-corrugated core is obtained from flat ring of shape memory alloy that is shape-memorized in advance to the transverse tension under temperature of martensite state of the shape memory alloy to provide negative creep effect under operating conditions.

### CONCLUSION, RAMIFICATIONS, and SCOPE

Presented novel type of gasket with corrugated core manufactured from shape memory alloy and shape-memorized in advance to the “swelling” being deformed by clamping forces due to bolt preload displays a negative creep effect resulting from reactive shape recovering stresses that appear between rigid flange surfaces and deformed corrugation when operating temperature will be close to temperature of reverse martensitic phase transformation of the shape memory alloy and constrained shape recovery generates these reactive shape-recovering stresses having direction inverse to the direction of operating creep of the gasket.

The negative creep effect of novel type of gasket is a basis to limit or inhibit plant/piping leakages providing tight, automatic and continuous multiple seal and ensuring a leak-tight contact between adjacent members of critical technological equipment under conditions of high internal pressures and a variety of operating temperatures if these temperatures will be close to the temperatures of reverse martensitic phase transformation of the shape memory alloy from which the gasket core is manufactured.

The negative creep gasket will find a large applicability in critical plant/piping systems used in petroleum refining, petrochemicals, natural gas liquefaction, fossil fuel and nuclear power generation, automobile, aerospace, submarine shipbuilding, and other industries.

The scope of application of the negative creep gaskets is limited by existing types of shape memory alloys, but successful development of materials science will inevitable provide any necessary shape memory alloys to cover the needs of modern critical industries.

I claim:

1. A gasket with core of shape memory alloy having a feature of negative creep effect and providing leak-tight, automatic and continuous multiple seal of critical plant/piping systems under a variety of operating temperatures and internal pressures.

2. A gasket according to claim 1 wherein said multiple seal results from corrugated gasket core encapsulated by protective envelope manufactured from materials convenient for specific operating conditions such as fires, oxidation, chemical influences, and others.

3. A gasket according to claim 1 wherein said negative creep effect of the gasket results from reactive shape-recovering stresses that appear between gasket corrugation deformed by bolt preload forces and rigid flange surfaces under conditions of a variety of operating temperatures and constrained shape recovery of deformed gasket corrugation.

4. A gasket according to claim 2 wherein said shape memory alloys have temperatures of reverse martensitic phase transformation that are close to operating temperatures of the assembly.

5. A gasket according to claim 2 wherein said corrugated gasket core is combined with additional non-corrugated portion of the gasket manufactured from the same shape memory alloys with the same protective envelope or from conventional gasket materials, and located on inner edge of the gasket.

6. A gasket according to claims 3 and 5 wherein said reactive shape-recovering stresses have direction inverse to the direction of operating creep providing gasket “swelling”.

7. A “forced fixation technique” to fabricate corrugated gasket core while deforming a flat ring of the shape memory alloy to obtain a stress-induced martensite under conditions of temperature of martensite state and rigidly fixed corrugation followed by aging obtained and rigidly fixed corrugation under temperature significantly greater than temperature of austenite state of the shape memory alloy with subsequent release the corrugation from rigid fixation under temperature of martensite state.
